(19) United States
(12) Patent Application Publication
(10) Pub. No.: US 2022/0295472 A1
(43) Pub. Date: Sep. 15, 2022

(54) USER TERMINAL AND RADIO COMMUNICATION METHOD

(71) Applicant: NTT DOCOMO, INC., Tokyo (JP)

(72) Inventors: Yuki Matsumura, Tokyo (JP); Masaya Okamura, Tokyo (JP); Hiroki Harada, Tokyo (JP); Satoshi Nagata, Tokyo (JP)

(73) Assignee: NTT DOCOMO, INC., Tokyo (JP)

(21) Appl. No.: 17/608,099

(22) PCT Filed: May 2, 2019
(86) PCT No.: PCT/JP2019/018191

§ 371 Date: Nov. 1, 2021

(51) Int. Cl. H04W 72/04; H04L 5/00

(52) U.S. Cl. CPC H04W 72/0413; H04W 72/0453; H04L 5/0051

(57) ABSTRACT

A user terminal according to an aspect of the present disclosure includes a receiving section that receives control information for transmission of an uplink signal in a certain band, and a control section that performs control to allocate, to a plurality of sets of frequency resources less than 1 resource block included in the certain band, corresponding parts of the uplink signal that correspond to the plurality of sets, and simultaneously transmit the corresponding parts of the uplink signal. According to an aspect of the present disclosure, it is possible to appropriately control full power transmission.

### TECHNICAL FIELD

The present disclosure relates to a user terminal and a radio communication method in next-generation mobile communication systems.

### BACKGROUND ART

In a Universal Mobile Telecommunications System (UMTS) network, the specifications of Long-Term Evolution (LTE) have been drafted for the purpose of further increasing high speed data rates, providing lower latency and so on (see Non-Patent Literature 1). In addition, for the purpose of further high capacity, advancement and the like of the LTE (Third Generation Partnership Project (3GPP) Release (Rel.) 8 and Rel. 9), the specifications of LTE-Advanced (3GPP Rel. 10 to Rel. 14) have been drafted.

Successor systems of LTE (e.g., referred to as “5th generation mobile communication system (5G),” “5G+(plus),” “New Radio (NR),” “3GPP Rel. 15 (or later versions),” and so on) are also under study.

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

For future radio communication systems (e.g., NR), supporting codebook-based transmission using a precoding matrix is under study.

However, in conventional Rel-15 NR specifications, when a UE performs the codebook-based transmission by using a plurality of ports, using a part of codebooks may lower transmit power as compared to the codebook-based transmission using a single port (full power transmission is not available). For example, when a power amplifier (PA) connected to a part of antenna ports is not a PA (full rated PA) that can output maximum rated power, full power transmission may not be available. When full power transmission is not available, coverage reduction and the like may occur, and an increase in communication throughput may be suppressed.

Thus, an object of the present disclosure is to provide a user terminal and a radio communication method that can appropriately control full power transmission.

### Solution to Problem

A user terminal according to an aspect of the present disclosure includes a receiving section that receives control information for transmission of an uplink signal in a certain band, and a control section that performs control to allocate, to a plurality of sets of frequency resources less than 1 resource block included in the certain band, corresponding parts of the uplink signal that correspond to the plurality of sets, and simultaneously transmit the corresponding parts of the uplink signal.

### Advantageous Effects of Invention

According to an aspect of the present disclosure, it is possible to appropriately control full power transmission.

### BRIEF DESCRIPTION OF DRAWINGS

FIG. 1 is a diagram to show an example of an association between a precoder type and a TPMI index;

FIG. 2 is a diagram to show an example of UE structures assumed by UE capability 1 to UE capability 3 related to full power transmission;

FIG. 3 is a diagram to show an example in which a UE having UE capability 2 performs full power transmission by using FDM;

FIGS. 4A and 4B are diagrams to show a technical challenge of FDM-based full power transmission;

FIG. 5 is a diagram to show an example of FDM-based full power transmission according to one embodiment;

FIGS. 6A and 6B are diagrams to show an example of an RE pattern for an RE set;

FIG. 7 is a diagram to show a first example of reference signal sequence allocation to each antenna port;

FIG. 8 is a diagram to show a second example of reference signal sequence allocation to each antenna port;

FIG. 9 is a diagram to show a third example of reference signal sequence allocation to each antenna port;

FIG. 10 is a diagram to show an example of a schematic structure of a radio communication system according to one embodiment;

FIG. 11 is a diagram to show an example of a structure of a base station according to one embodiment;

FIG. 12 is a diagram to show an example of a structure of a user terminal according to one embodiment; and

FIG. 13 is a diagram to show an example of a hardware structure of the base station and the user terminal according to one embodiment.

### DESCRIPTION OF EMBODIMENTS

### (PUSCH Precoder)

For NR, a UE that supports at least one of codebook (CB)-based transmission and non-codebook (NCB)-based transmission is under study.

For example, the UE that judges a precoder (precoding matrix) for at least one of CB-based and NCB-based uplink shared channel (Physical Uplink Shared Channel (PUSCH)) transmission by using at least a sounding reference signal (SRS) resource index (SRI) is under study.

In a case of CB-based transmission, the UE may determine the precoder for PUSCH transmission on the basis of the SRI, a transmitted rank indicator (TRI), a transmitted precoding matrix indicator (TPMI), and the like. In a case of NCB-based transmission, the UE may determine the precoder for PUSCH transmission on the basis of the SRI.

The SRI, TRI, TPMI, and the like may be notified to the UE with use of downlink control information (DCI). The SRI may be designated by an SRS Resource Indicator field (SRI field) in the DCI, or may be designated by a parameter “srs-ResourceIndicator” included in an RRC information element “ConfiguredGrantConfig” for a configured grant PUSCH. The TRI and TPMI may be designated by a Precoding information and number of layers field in the DCI.

The UE may report UE capability information related to a precoder type, and a precoder type based on the UE capability information may be configured for the UE by higher layer signaling from a base station. The UE capability information may be precoder type information (which may be represented by an RRC parameter “pusch-TransCoherence”) used by the UE for PUSCH transmission.

In the present disclosure, the higher layer signaling may be, for example, any one or combinations of Radio Resource Control (RRC) signaling, Medium Access Control (MAC) signaling, broadcast information, and the like.

The MAC signaling may use, for example, a MAC control element (MAC CE), a MAC Protocol Data Unit (PDU), or the like. The broadcast information may be, for example, a master information block (MIB), a system information block (SIB), or the like.

The UE may determine the precoder used for PUSCH transmission on the basis of precoder type information (which may be represented by an RRC parameter “codebookSubset”) included in PUSCH configuration information (“PUSCH-Config” information element for RRC signaling) notified by the higher layer signaling. A subset of PMIs designated by the TPMI may be configured for the UE by the codebookSubset.

Note that the precoder type may be designated by any one or combinations of at least two of fully coherent (full coherent, coherent), partial coherent (partially coherent), and non-coherent (non coherent) (for example, the combination may be represented by a parameter such as “fully, partial, and non-coherent (fullyAndPartialAndNonCoherent)” and “partial and non-coherent (partialAndNonCoherent)”).

The fully coherent may mean that all antenna ports used for transmission are synchronized (which may be expressed as phase matching is available, the precoder to be applied is the same, or the like). The partial coherent may mean that some ports of antenna ports used for transmission are synchronized with each other, but the some ports are not synchronized with another port. The non-coherent may mean that each antenna port used for transmission is not synchronized.

Note that the UE that supports the fully coherent precoder type may be assumed to support the partial coherent and non-coherent precoder type. The UE that supports the partial coherent precoder type may be assumed to support the non-coherent precoder type.

The precoder type may be interpreted as coherency, PUSCH transmission coherence, a coherent type, a coherence type, a codebook type, a codebook subset, a codebook subset type, and the like.

The UE may determine a precoding matrix corresponding to a TPMI index obtained for DCI to schedule UL transmission on the basis of a plurality of precoders (which may be referred to as precoding matrices, codebooks, and so on) for CB-based transmission.

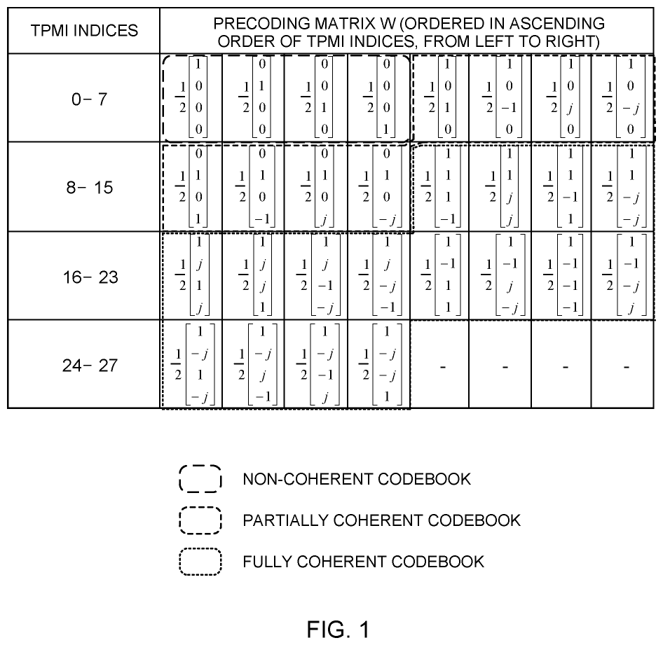

FIG. 1 is a diagram to show an example of an association between the precoder type and the TPMI index. FIG. 1 corresponds to a table for a precoding matrix W for single layer transmission using 4 antenna ports in DFT-s-OFDM (Discrete Fourier Transform spread OFDM, transform precoding is enabled).

In FIG. 1, when a precoder type (codebookSubset) is fully, partial, and non-coherent (fullyAndPartialAndNonCoherent), any one of TPMIs 0 to 27 is notified to the UE to single layer transmission. When the precoder type is partial and non-coherent (partialAndNonCoherent), any one of TPMIs 0 to 11 is configured for the UE to single layer transmission. When the precoder type is non-coherent (nonCoherent), any one of TPMIs 0 to 3 is configured for the UE to single layer transmission.

FIG. 1 is a table that is defined in current Rel-15 NR. In this table, letting transmit power for fully coherent corresponding to indices 12 to 27 be 1 (=(½)²*4), transmit power for partial coherent corresponding to indices 4 to 11 is ½ (=(½)²*2), and transmit power for non-coherent corresponding to indices 0 to 3 is ¼ (=(½)²*1).

In other words, according to the current Rel-15 NR specifications, when the UE performs codebook-based transmission by using a plurality of ports, using a part of codebooks may lower transmit power as compared to the codebook-based transmission using a single port (full power transmission is not available).

Note that as shown in FIG. 1, a precoding matrix in which only one of elements of each row is not zero may be referred to as a non-coherent codebook. A precoding matrix in which only a certain number of elements of each row (except all of the elements) is not zero may be referred to as a partial coherent codebook. A precoding matrix in which none of elements of each row are zero may be referred to as a fully coherent codebook.

Note that in the present disclosure, the partial coherent codebook may correspond to a codebook obtained by removing a codebook corresponding to a TPMI designated for the UE for which a non-coherent codebook subset (e.g., an RRC parameter “codebookSubset”=“nonCoherent”) is configured from codebooks (precoding matrices) corresponding to a TPMI designated by DCI for codebook-based transmission by the UE for which a partial coherent codebook subset (e.g., an RRC parameter “codebookSubset”=“partialAndNonCoherent”) is configured (in other words, a codebook with TPMIs=4 to 11 in a case of single layer transmission with 4 antenna ports).

Note that in the present disclosure, the fully coherent codebook may correspond to a codebook obtained by removing a codebook corresponding to a TPMI designated for the UE for which a partial coherent codebook subset (e.g., an RRC parameter “codebookSubset”=“partialAndNonCoherent”) is configured from codebooks (precoding matrices) corresponding to a TPMI designated by DCI for codebook-based transmission by the UE for which a fully coherent codebook subset (e.g., an RRC parameter “codebookSubset”=“fullyAndPartialAndNonCoherent”) is configured (in other words, a codebook with TPMIs=12 to 27 in a case of single layer transmission with 4 antenna ports).

### (UE Capability for Full Power Transmission)

Performing full power UL transmission appropriately is preferable even when a codebook is used. Thus, for NR, UE capability related to codebook-based full power UL transmission using a plurality of power amplifiers (PAs) are under study. In discussions of the NR thus far, UE capability 1 to UE capability 3 have been proposed as follows:

UE capability 1: a PA (full rated PA) that can output maximum rated power is supported (or included) in respective transmission chains (Tx chains),

UE capability 2: none of the transmission chains support the full rated PA, and

UE capability 3: a subset (part) of the transmission chains supports the full rated PA.

Note that the UE having at least one of UE capability 1 to UE capability 3 may mean that full power for UL transmission is supported. Apart from UE capability 1 to UE capability 3, the UE may report capability information indicating that UL full power transmission capability is supported to a network (e.g., the base station).

UE capability 1/2/3 may be interpreted as UE capability 1/2/3 related to full power transmission, full power transmission type 1/2/3, power allocation type 1/2/3, and so on, respectively. Here, the type may be interpreted as a mode, capability, and so on. 1/2/3 may be interpreted as a set of arbitrary numbers or letters, such as A/B/C.

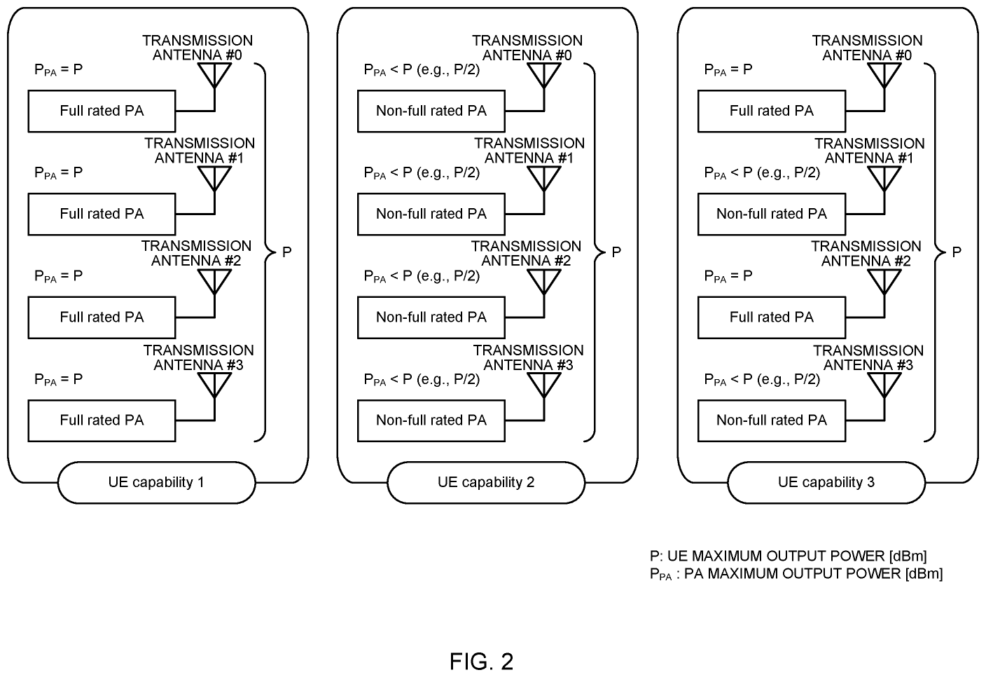

FIG. 2 is a diagram to show an example of UE structures assumed by UE capability 1 to UE capability 3 related to full power transmission. FIG. 2 briefly shows only PAs and transmission antenna ports (which may be interpreted as transmission antennas) as the UE structures. Note that FIG. 2 shows an example in which the number of the PAs and the number of the transmission antenna ports are both 4, but the present disclosure is not limited to this.

Note that P denotes UE maximum output power [dBm], and P_{PA} denotes PA maximum output power [dBm]. Note that P may be, for example, 23 dBm in a power class 3 UE, and may be, for example, 26 dBm in a power class 2 UE. The present disclosure assumes P_{PA}≤P, but embodiments according to the present disclosure may be employed in a case where P_{PA}>P.

A structure for UE capability 1 is assumed to be higher cost in implementation, but the structure can perform full power transmission by using one or more arbitrary antenna ports. A structure for UE capability 2 includes only non-full rated PAs and is expected to be implementable at a lower cost. However, using only one antenna port does not enable full power transmission, and thus controlling of a phase, amplitude, and the like of a signal input into each PA is needed.

A structure for UE capability 3 is in the middle of the structure for UE capability 1 and the structure for UE capability 2. Antenna ports (in the present example, transmission antennas #0 and #2) that can perform full power transmission coexist with antenna ports (in the present example, transmission antennas #1 and #3) that cannot perform full power transmission.

Note that indices, the number, and the like of the antenna ports of UE capability 3 that can perform full power transmission are not limited to this. The present example assumes non-full rated PA P_{PA}=P/2, but a value of P_{PA} is not limited to this.

Incidentally, in order to allow the UE to perform full power transmission in UE capability 2, simultaneous transmission with a plurality of antenna ports using frequency division multiplex (FDM) is under study.

In this method, resource blocks (RBs) (which may be referred to as physical RBs (PRBs)) to be scheduled are divided into a plurality of resource block sets (RB sets). Each RB set is related to a corresponding antenna port (or antenna port set). A minimum size of the RB set may be 1 RB.

An antenna port in one RB set may be assumed to be coherent. In this case, non-coherent transmission resources are separated, and thus channel measurement can be performed accurately. The UE may apply a different precoder (precoding matrix) for each RB set.

Note that this method may be employed in either or both of Cyclic Prefix OFDM (CP-OFDM) and DFT-s-OFDM. In a case of DFT-s-OFDM, one DFT may be applied to one RB set.

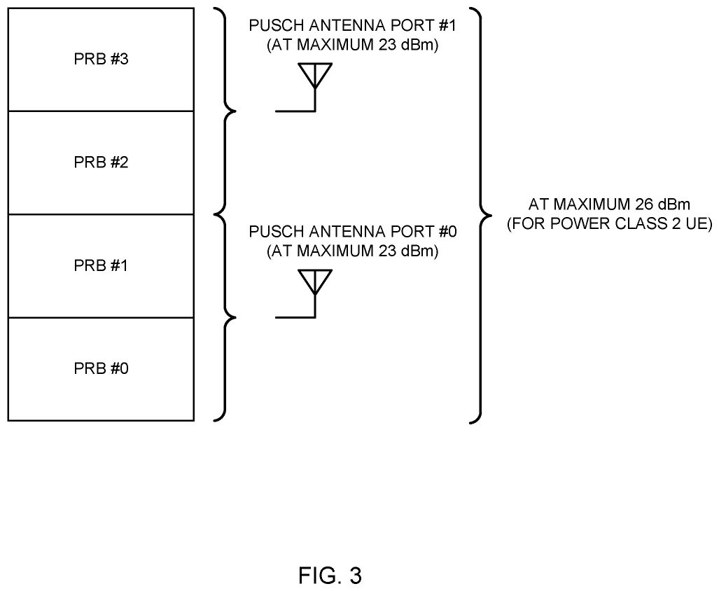

FIG. 3 is a diagram to show an example in which the UE having UE capability 2 performs full power transmission by using FDM. In the present example, with respect to single layer PUSCH transmission, four PRBs (PRBs #0 to #3) are allocated to the UE. The UE uses only antenna port #0 for PUSCH transmission using a first RB set (PRBs #0 and #1), and uses only antenna port #1 for PUSCH transmission using a second RB set (PRBs #2 and #3).

It may be assumed that a first precoding matrix (e.g., [1, 0]) is applied to the first RB set and a second precoding matrix (e.g., [0, 1]) is applied to the second RB set.

When the UE can perform PUSCH transmission using antenna port #0 and PUSCH transmission using antenna port #1, each with at maximum 23 dBm, for example, the UE can perform transmission with at maximum 26 dBm corresponding to the power class 2 UE by performing such transmissions simultaneously.

Note that in order to perform transmission with at maximum 23 dBm corresponding to the power class 3 UE, it is only necessary that the UE performs PUSCH transmission using antenna port #0 and PUSCH transmission using antenna port #1, each with at maximum 20 dBm, for example.

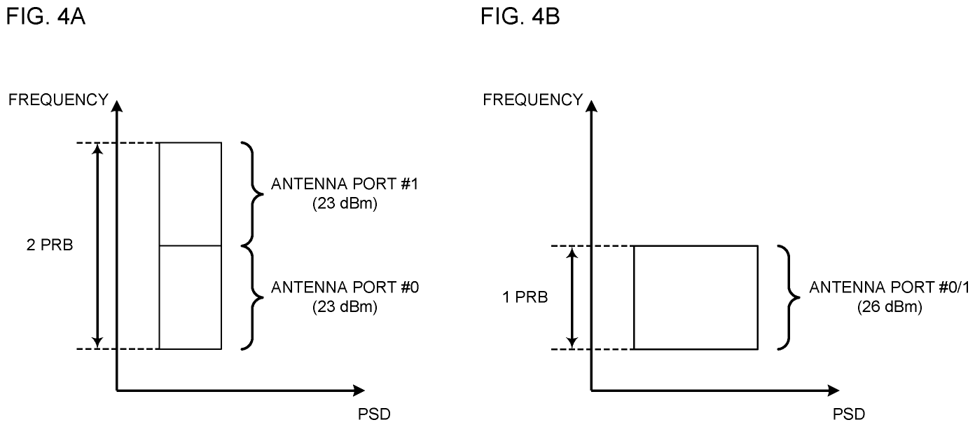

However, a technical challenge exists in the above-mentioned FDM-based full power transmission. FIGS. 4A and 4B are diagrams to show the technical challenge of the FDM-based full power transmission. As shown in FIG. 4A, it is necessary that at least 2 PRBs are allocated to the UE in the FDM-based full power transmission that has been studied thus far.

Thus, the UE to which 1 PRB is allocated cannot perform full power transmission. For example, with respect to the UE at a cell edge or the like, control for improvement in power spectral density (PSD), a signal-to-noise ratio, and the like with power boosting by reducing allocated bandwidth (the number of PRBs) may be performed by the network. In such control, 1 PRB allocation may occur.

As shown in FIG. 4B, a technique that can achieve full power transmission (in the present example, 26 dBm transmission) by using antenna port #0/#1 even with 1 PRB is desired. When full power transmission is not available, coverage reduction and the like may occur, and an increase in communication throughput may be suppressed.

Thus, the inventors of the present invention came up with the idea of a control method for appropriately performing full power transmission. According to an aspect of the present disclosure, it is possible to perform UL MIMO (Multi Input Multi Output) transmission at full power, and cell coverage similar to that of a single antenna can be maintained. According to UL MIMO, it is possible to obtain spatial diversity gain, and throughput improvement can be expected. Even a UE without a full rated PA can perform full power transmission appropriately.

Embodiments according to the present disclosure will be described in detail with reference to the drawings as follows. The radio communication methods according to respective embodiments may each be employed individually, or may be employed in combination.

Note that the terms “antenna” and “antenna port” in embodiments below may be interchangeably interpreted.

In the present disclosure, having UE capability X (X=1, 2, and 3), reporting the UE capability X, capability to perform full power transmission by using a structure for the UE capability X, and so on may be interchangeably interpreted.

In the present disclosure, having capability related to coherent (e.g., fully coherent, partial coherent, and non-coherent), reporting the capability, a case that the coherence is configured, and so on may be interchangeably interpreted.

A non-coherent UE, a partial coherent UE, and a fully coherent UE may be interchangeably interpreted as a UE having capability related to non-coherence, a UE having capability related to partial coherence, and a UE having a capability related to fully coherent, respectively.

A non-coherent UE, a partial coherent UE, and a fully coherent UE may mean a UE for which “non-coherent (nonCoherent),” “partial and non-coherent (partialAndNonCoherent),” and “fully, partial, and non-coherent (fullyAndPartialAndNonCoherent)” codebook subset is configured by a higher layer, respectively. Note that in the present disclosure, a codebook subset and a codebook may be interchangeably interpreted.

A non-coherent UE, a partial coherent UE, and a fully coherent UE may mean a UE that can perform transmission using a non-coherent codebook, a partial coherent codebook, and a fully coherent codebook, respectively.

Note that the UE of embodiments below may be interpreted as a non-coherent UE having UE capability 2, a partial coherent UE having UE capability 2, and so on. However, scope of employment of the present disclosure is not limited to this, and a radio communication method based on the embodiments below may be employed in an arbitrary UE regardless of UE capability 1 to UE capability 3.

A “set” in the present disclosure may be interpreted as a group.

### (Radio Communication Method)

When the UE has reported either or both of capability information indicating that UL full power transmission capability is supported and UE capability 2 to the network, the UE may perform at least one operation according to the embodiments described below.

When configuration information to allow (or enable) UL full power transmission (e.g., UL full power transmission based on UE capability 2) has been notified to the UE from the network, the UE may perform at least one operation according to the embodiments described below.

Note that the UE may be at least one of a non-coherent UE, a partial coherent UE, and a fully coherent UE.

The UE may use different antenna ports the number of which is the number of antenna ports (e.g., an RRC parameter “nrofSRS-Ports”) for SRSs configured by higher layer signaling (e.g., RRC signaling) to transmit the same PUSCH simultaneously by using FDM.

In one embodiment, an RB or a resource element (RE) to be scheduled may be divided into a plurality of resource element sets (RE sets). Each RE set is related to a corresponding antenna port (or antenna port set). A minimum size of the RE set may be 1 RE.

With respect to the RE set, the present disclosure assumes that the sum of bands for frequency resources included in the set is less than 1 PRB, but the sum is not limited to this. For example, with respect to the RE set, the sum of bands for frequency resources included in the set may be 1 PRB or more.

Note that the RB or the RE to be scheduled may correspond to a bandwidth equal to or greater than 1 PRB, or may correspond to a bandwidth less than 1 PRB.

An antenna port in one RE set may be assumed to be coherent. Note that this method may be employed in either or both of CP-OFDM and DFT-s-OFDM. In a case of DFT-s-OFDM, one DFT may be applied to one RE set.

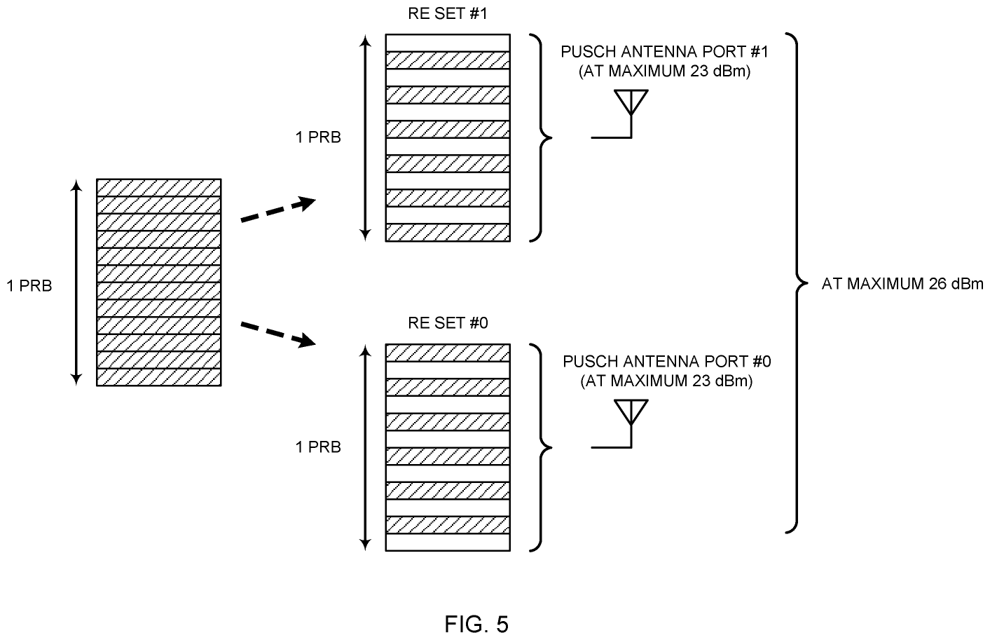

FIG. 5 is a diagram to show an example of FDM-based full power transmission according to one embodiment. In the present example, the UE divides a certain number (e.g., 12) of subcarriers in one PRB into two RE sets (RE sets #0 and #1). The UE uses only antenna port #0 for PUSCH transmission using a first RE set (RE set #0), and uses only antenna port #1 for PUSCH transmission using a second RE set (RE set #1).

The UE may assume that a first precoding matrix (e.g., [1, 0]) is applied to the first RE set (e.g., RE set #0) and a second precoding matrix (e.g., [0, 1]) is applied to the second RE set (e.g., RE set #1). Here, it is preferable that the first precoding matrix and the second precoding matrix be matrices orthogonal to each other.

The UE may simultaneously transmit the first RE set with a first transmit power (e.g., at maximum 23 dBm) and the second RE set with a second transmit power (e.g., at maximum 23 dBm). The total transmit power of these may be controlled so as to reach P (e.g., 26 dBm (in a case of a power class 2 UE)).

### <RE Pattern>

The UE may identify a frequency resource corresponding to the RE set by an RE pattern (which may be referred to as a location configuration for the RE set). It is preferable that frequency resources for RE sets be constituted such that the frequency resources do not overlap with each other.

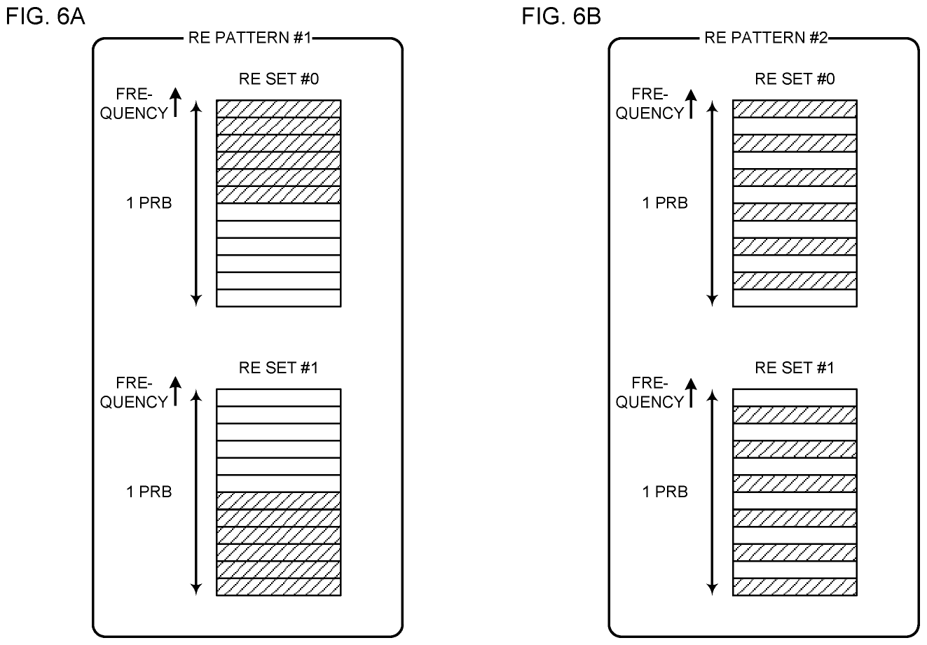

FIGS. 6A and 6B are diagrams to show an example of the RE pattern for the RE set. The present example shows the RE pattern including two RE sets in 1 PRB (in other words, the RE pattern corresponding to transmission using 2 antenna ports), but the present disclosure is not limited to this. For example, the RE pattern corresponding to transmission using 4 antenna ports may be constituted by including four RE sets in 1 PRB. The RE pattern may indicate a location of an RE set in a frequency band broader than 1 PRB (e.g., 2 PRBs).

Note that description of the present disclosure is given based on an assumption that 12 subcarriers are included in 1 PRB, but the number of subcarriers included in 1 PRB is not limited to this.

FIG. 6A is a diagram to show an example of RE pattern #1. In RE pattern #1, each RE set is located in continuous subcarriers. In the example of FIG. 6A, RE set #0 is constituted by 6 continuous subcarriers (subcarrier numbers 6 to 11) having higher frequency in 1 PRB, and RE set #1 is constituted by 6 continuous subcarriers (subcarrier numbers 0 to 5) having lower frequency in 1 PRB.

According to RE pattern #1 as described above, a frequency range of the RE set is narrow, and thus reduction of signal interference between RE sets can be expected (a possibility of occurrence of interference due to REs shifted by Doppler shift can be suppressed).

FIG. 6B is a diagram to show an example of RE pattern #2. In RE pattern #2, each RE set is located in every other (discrete) subcarrier. For example, subcarrier numbers of RE set #0 may be odd numbers (1, 3, . . . , 11), and subcarrier numbers of RE set #1 may be even numbers (0, 2, . . . , 10). Such a subcarrier arrangement may be referred to as a comb-shaped subcarrier arrangement.

According to RE pattern #2 as described above, a frequency range of the RE set is broad, and thus a frequency diversity effect between RE sets can be obtained preferably.

An RE pattern used by the UE may be determined beforehand by a specification, or one or a plurality of RE patterns may be configured by higher layer signaling.

When UL full power transmission target is a data symbol, the UE may switch, on the basis of whether DFT precoding is applied to the data symbol (whether transform precoding is enabled), the RE pattern to be used.

The UE may also switch, on the basis of which of a data symbol or a reference signal symbol the UL full power transmission target is, the RE pattern to be used (for example, the UE may judge that the RE pattern to be used for the data symbol is different from that for the reference signal symbol).

Note that the data symbol may be, for example, a symbol for transmitting a PUSCH. The reference signal symbol may be, for example, a symbol for transmitting at least one of a demodulation reference signal (DMRS), an SRS, and the like for a PUSCH.

Note that the RE pattern may be assumed to be the same through a band (e.g., an allocated PRB for a PUSCH) to which a UL signal is allocated, or may be assumed to be different for each certain frequency resource (e.g., for each PRB). Correspondence between a frequency resource and an RE pattern may be configured for the UE by higher layer signaling. For example, the UE is configured to use RE pattern #1 in frequency band A and use RE pattern #2 in frequency band B.

### <Signal Allocation to RE Set>

### [DMRS/SRS Sequence]

The UE may generate, on the basis of a sequence length determined with use of at least one of the number of allocated PRBs (bandwidth) for data (PUSCH) and a DMRS type (which may be referred to as a DMRS configuration type), a reference signal sequence (e.g., a DMRS sequence or an SRS sequence) allocated to a plurality of antenna ports with use of an RE set.

The UE may divide the generated reference signal sequence into RE sets corresponding to each antenna port. The UE may allocate the divided reference signal sequence for an RE set to an RE location (a location identified on the basis of an RE pattern) of the RE set.

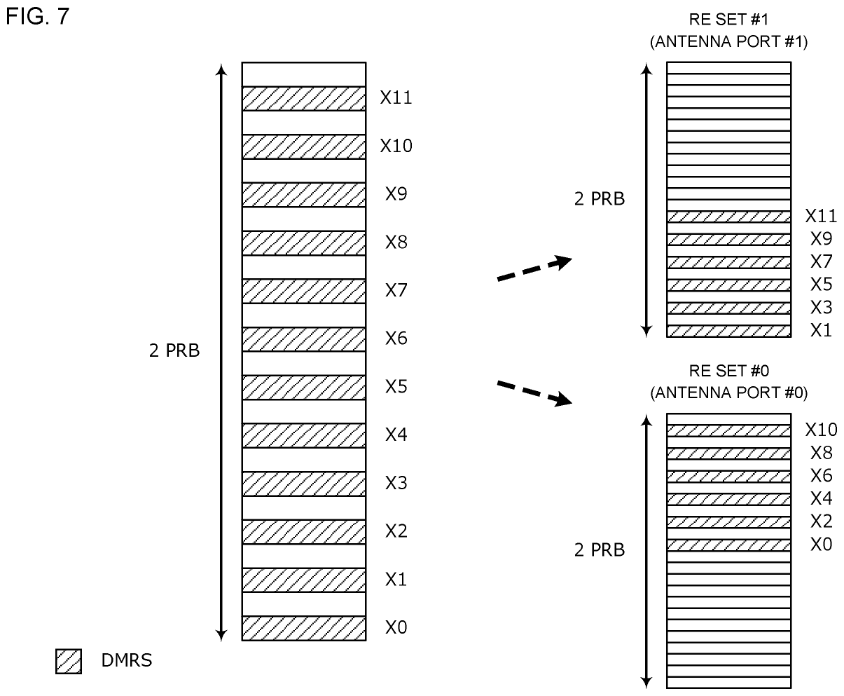

FIG. 7 is a diagram to show a first example of the reference signal sequence allocation to each antenna port. The left side of FIG. 7 shows an example of an arrangement of DMRSs corresponding to normal PUSCH transmission, and the right side of FIG. 7 shows an example of an arrangement of DMRSs for each RE set.

As shown in the left side of FIG. 7, the present example assumes that a frequency resource for a PUSCH to be scheduled is 2 PRBs and is a DMRS type 1 (comb-shaped DMRS mapping). In this case, in a case of normal PUSCH transmission, elements of a sequence having a sequence length 12 {X0, X1, . . . , X11} corresponding to 2 PRBs are arranged in every other subcarrier.

In a case of performing PUSCH full power transmission based on the RE set, as shown in the right side of FIG. 7, the UE may allocate part (e.g., {X0, X2, X4, X6, X8, X10}) of the above-described sequence having the sequence length 12 to RE set #0 (antenna port #0), and may allocate the rest (e.g., {X1, X3, X5, X7, X9, X11}) of the above-described sequence having the sequence length 12 to RE set #1 (antenna port #1).

In a way of allocation shown in the right side of FIG. 7, each PRB of illustrated 2 PRBs is allocated to a different RE set (antenna port). According to such an RE pattern, a frequency range of the RE set is narrow, and thus reduction of signal interference between RE sets can be expected (a possibility of occurrence of interference due to REs shifted by Doppler shift can be suppressed).

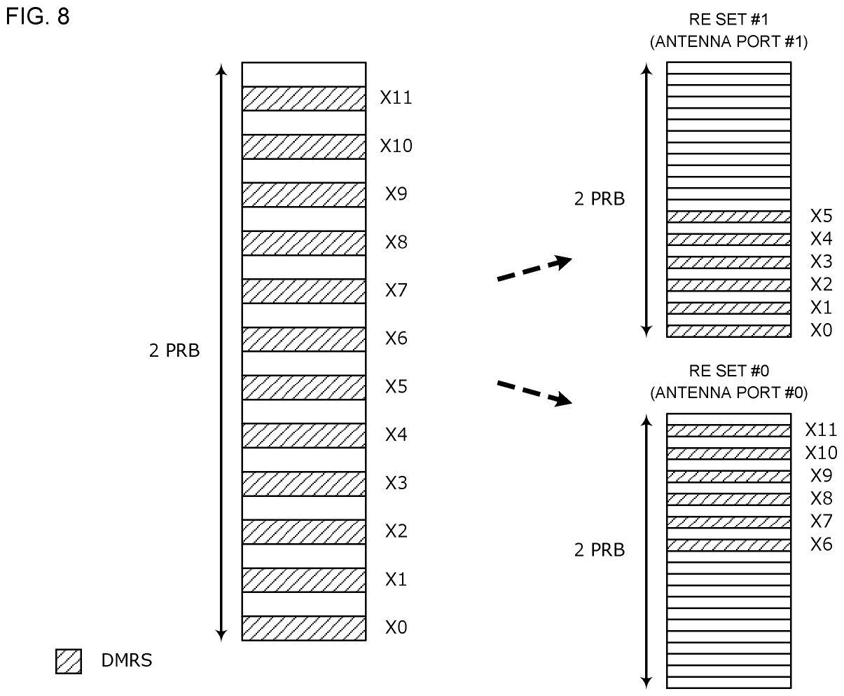

FIG. 8 is a diagram to show a second example of the reference signal sequence allocation to each antenna port. FIG. 8 is the same as FIG. 7 except that sequence allocation in DMRS arrangement for each RE set differs from that of FIG. 7, and thus overlapping descriptions will not be repeated.

In a case of performing PUSCH full power transmission based on the RE set, as shown in the right side of FIG. 8, the UE may allocate part (e.g., {X6, X7, X8, X9, X10, X11}) of the above-described sequence having the sequence length 12 to RE set #0 (antenna port #0), and may allocate the rest (e.g., {X0, X1, X2, X3, X4, X5}) of the above-described sequence having the sequence length 12 to RE set #1 (antenna port #1).

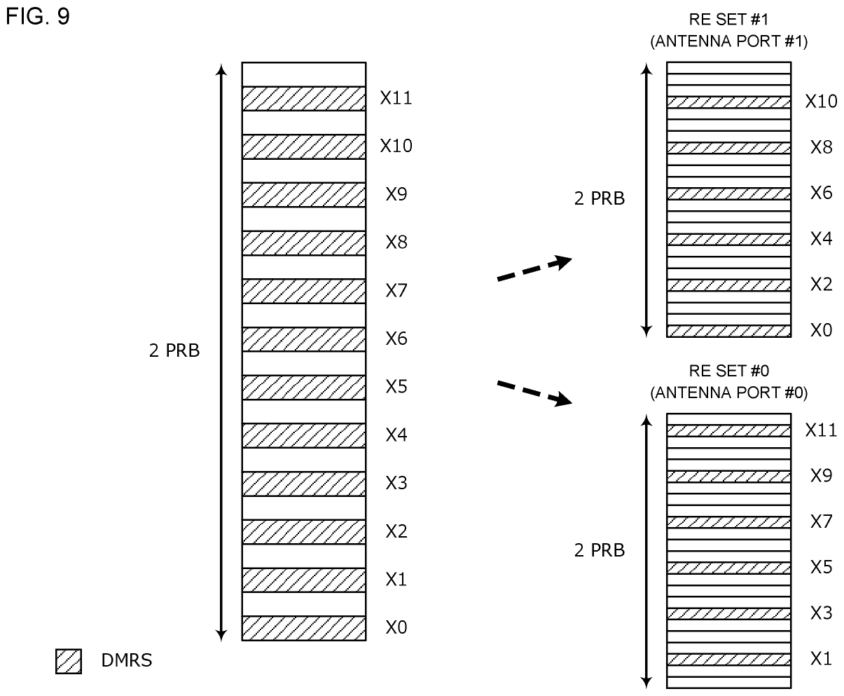

FIG. 9 is a diagram to show a third example of the reference signal sequence allocation to each antenna port. FIG. 9 is the same as FIG. 7 except that sequence allocation in DMRS arrangement for each RE set differs from that of FIG. 7, and thus overlapping descriptions will not be repeated.

In a case of performing PUSCH full power transmission based on the RE set, as shown in the right side of FIG. 9, the UE may allocate part (e.g., {X1, X3, X5, X7, X9, X11}) of the above-described sequence having the sequence length 12 to RE set #0 (antenna port #0), and may allocate the rest (e.g., {X0, X2, X4, X6, X8, X10}) of the above-described sequence having the sequence length 12 to RE set #1 (antenna port #1).

In a way of allocation shown in the right side of FIG. 9, each PRB of illustrated 2 PRBs includes both RE sets (antenna ports). According to such an RE pattern, a frequency range of the RE set is broad, and thus a frequency diversity effect between RE sets can be obtained preferably.

Indices of sequence to be mapped to each RE are not limited to examples of FIG. 7 to FIG. 9.

Note that different methods of sequence generation/allocation may be used. For example, the UE may generate a sequence per RE set on the basis of REs actually used in each RE set (antenna port) (e.g., on the basis of at least one of a location and the number of the REs actually used) to allocate the sequence to an RE location of each RE set.

For example, when it is assumed that a frequency resource for a PUSCH to be scheduled is 2 PRBs and DMRS type 1 (comb-shaped DMRS mapping) is employed, a sequence having a length 6 may be generated independently with respect to each RE set (antenna port).

The UE may allocate a generated first sequence {X1, X2, X3, X4, X5, X6} to RE set #0 (antenna port #0), and may allocate a generated second sequence {Y1, Y2, Y3, Y4, Y5, Y6} to RE set #1 (antenna port #1).

Note that the sequences X and Y for respective antenna ports may correspond to the same sequence (may be generated from the same equation), or may correspond to different sequences.

The UE may generate, as a sequence with a specific antenna port ID (index) (e.g., the lowest antenna port ID in simultaneous transmission), a sequence X configured or designated by the network. The UE may generate, as a sequence with another antenna port ID (e.g., the second lowest antenna port ID), a sequence determined on the basis of at least one of a sequence number and a cyclic shift number (e.g., a cyclic shift number for an SRS sequence) of the above-described sequence X.

With respect to each RE set, information related to a sequence for the RE set (or antenna port) may be configured for the UE by higher layer signaling.

### [Data]

The UE may divide a signal modulated and coded on the basis of the number of allocated PRBs for data (PUSCH) into RE sets corresponding to each antenna port. The UE may allocate the divided modulation signal for an RE set to an RE location (a location identified on the basis of an RE pattern) of the RE set.

For example, when a frequency resource for a PUSCH to be scheduled is 1 PRB, the UE may generate {X0, X1, . . . , X11} as the modulation signal. The UE may allocate part (e.g., {X0, X2, X4, X6, X8, X10}) of the above-described modulation signal to RE set #0 (antenna port #0), and may allocate the rest (e.g., {X1, X3, X5, X7, X9, X11}) of the above-described modulation signal to RE set #1 (antenna port #1).

Note that different methods of modulation signal generation/allocation may be used. For example, the UE may generate a modulation signal per RE set on the basis of REs actually used in each RE set (antenna port) (e.g., on the basis of at least one of a location and the number of the REs actually used) to allocate the modulation signal to an RE location of each RE set.

For example, when a frequency resource for a PUSCH to be scheduled is 1 PRB, the UE may generate, as the modulation signal, a modulation signal corresponding to 6 REs independently with respect to each RE set (antenna port).

The UE may allocate generated first modulation signal {X1, X2, X3, X4, X5, X6} to RE set #0 (antenna port #0), and may allocate generated second modulation signal {Y1, Y2, Y3, Y4, Y5, Y6} to RE set #1 (antenna port #1).

Note that in the present disclosure, the UE may apply DFT precoding (transform precoding) for each signal allocated to each antenna port.

Note that the sequences X and Y for respective antenna ports may correspond to the same sequence (may be generated from the same equation), or may correspond to different sequences.

The UE may generate, as a sequence with a specific antenna port ID (index) (e.g., the lowest antenna port ID in simultaneous transmission), a sequence X configured or designated by the network. The UE may generate, as a sequence with another antenna port ID (e.g., the second lowest antenna port ID), a sequence determined on the basis of at least one of a sequence number and a cyclic shift number of the above-described sequence X.

With respect to each RE set, information related to a sequence for the RE set (or antenna port) may be configured for the UE by higher layer signaling.

### [Switching Between FDM-Based Full Power Transmission Using RE Set and FDM-Based Full Power Transmission Using RB Set]

FDM-based full power transmission using an RE set described above may be switched for use, to FDM-based full power transmission using an RB set as mentioned above with reference to FIG. 3 and so on. The UE may control this switching on the basis of, for example, the number of antenna ports for UL signals, an allocated resource size (e.g., an allocated PRB for a PUSCH), or the like.

For example, in UL transmission using a certain number (e.g., 2 or 4) of antenna ports, when the number of allocated PRBs is a certain threshold (e.g., the number of antenna ports) or more, the UE may apply FDM-based full power transmission using an RB set to the UL signal. Otherwise, the UE may apply FDM-based full power transmission using an RE set to the UL signal, may apply full power transmission using a fully coherent codebook subset to the UL transmission even though the UE is a non-coherent UE or a partial coherent UE, or the like.

According to a first embodiment described above, the UE can appropriately perform FDM-based full power transmission even when a frequency domain resource for UL transmission to be allocated is less than 2 PRBs.

### <Others>

The above-mentioned embodiment describes UL transmission using an antenna port under assumption for a PUSCH, but full power transmission of at least one of another signal and channel in addition to or in place of the PUSCH may be controlled.

In other words, the antenna port of the above-mentioned embodiment may be an antenna port for at least one of a PUSCH (and a demodulation reference signal (DMRS) for a PUSCH), a phase tracking reference signal (PTRS), an uplink control channel (Physical Uplink Control Channel (PUCCH)), a random access channel (Physical Random Access Channel (PRACH)), an SRS, and the like.

In other words, the above-mentioned embodiment may be employed in only a data symbol, or may be employed in a combination of a DMRS symbol, an SRS symbol, and a data symbol. The DMRS/SRS symbol is assumed to have lower peak to average power ratio (PAPR) as compared to that of the data symbol, and thus can be appropriately received with a power backoff margin of a signal amplifier on a reception side (base station) without being transmitted at full power.

Note that the term “full power transmission (full power UL transmission)” of the present disclosure may be interpreted as at least one of the following:
UL transmission with higher transmit power as compared to that in a case where the same UL transmission (the same channel or reference signal) is transmitted using the same condition (e.g., the same codebook, the same TPMI, the same cumulative situation of Transmit Power Control (TPC) commands, or the like) in Rel. 15 NR,
UL transmission in a case where “high transmit power” is configured/notified/indicated by the network, and
UL transmission with higher transmit power as compared to UL transmission in a case where “high transmit power” is not configured/notified/indicated by the network.

Note that the case that “high transmit power” is (or is not) configured/notified/indicated may mean the case that information related to a specific transmit power type, a specific transmission mode, or a specific transmit power value is configured/notified/indicated.

### (Radio Communication System)

Hereinafter, a structure of a radio communication system according to one embodiment of the present disclosure will be described. In this radio communication system, the radio communication method according to each embodiment of the present disclosure described above may be used alone or may be used in combination for communication.

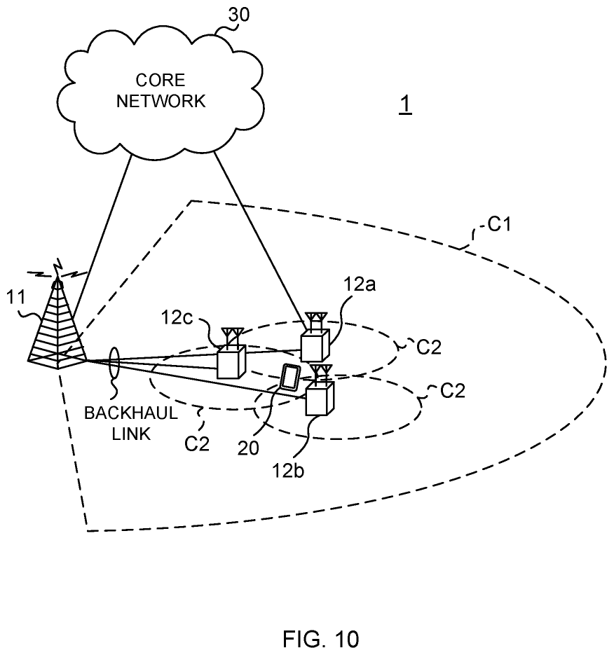

FIG. 10 is a diagram to show an example of a schematic structure of the radio communication system according to one embodiment. The radio communication system 1 may be a system implementing a communication using Long Term Evolution (LTE), 5th generation mobile communication system New Radio (5G NR) and so on the specifications of which have been drafted by Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FR1 may be a frequency band of 6 GHz or less (sub-6 GHz), and FR2 may be a frequency band which is higher than 24 GHz (above-24 GHz). Note that frequency bands, definitions and so on of FR1 and FR2 are by no means limited to these, and for example, FR1 may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.”

The base station 10 may be connected to a core network 30 through another base station 10 or directly. For example, the core network 30 may include at least one of Evolved Packet Core (EPC), 5G Core Network (5GCN), Next Generation Core (NGC), and so on.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DFT-s-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are communicated on the PDSCH. User data, higher layer control information and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data”, and the PUSCH may be interpreted as “UL data”.

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a certain search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be also referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block,” an “SS Block (SSB),” and so on. Note that an SS, an SSB, and so on may be also referred to as a “reference signal.”

In the radio communication system 1, a sounding reference signal (SRS), a demodulation reference signal (DMRS), and so on may be communicated as an uplink reference signal (UL-RS). Note that DMRS may be referred to as a “user terminal specific reference signal (UE-specific Reference Signal).”

### (Base Station)

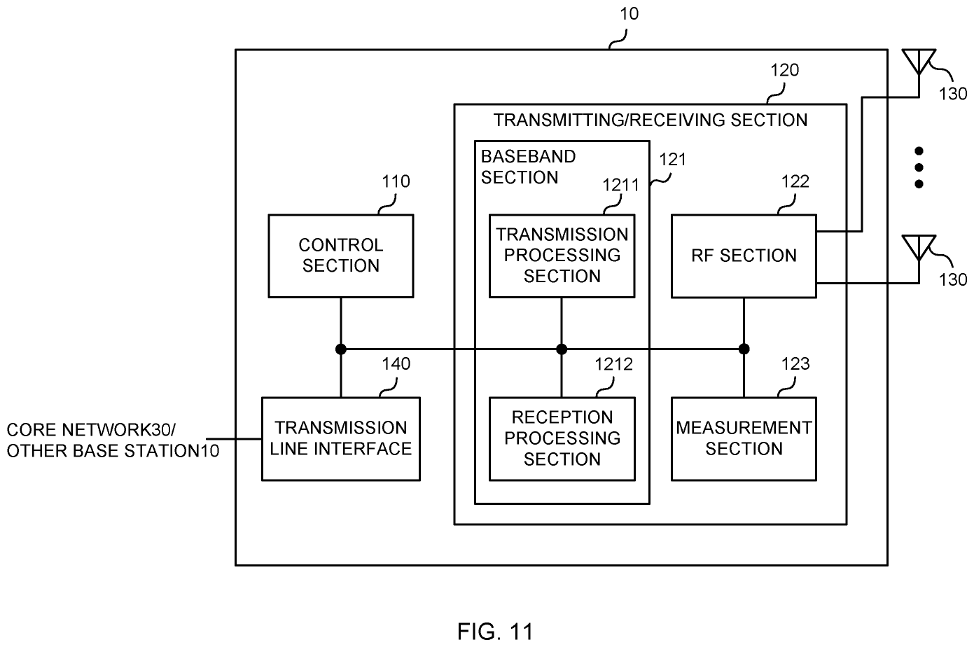

FIG. 11 is a diagram to show an example of a structure of the base station according to one embodiment. The base station 10 includes a control section 110, a transmitting/receiving section 120, transmitting/receiving antennas 130 and a transmission line interface (communication path interface) 140. Note that the base station 10 may include one or more control sections 110, one or more transmitting/receiving sections 120, one or more transmitting/receiving antennas 130, and one or more transmission line interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the transmission line interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The transmission line interface 140 may perform transmission/reception (backhaul signaling) of a signal with an apparatus included in the core network 30 or other base stations 10, and so on, and acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the transmission line interface 140.

Note that the transmitting/receiving section 120 may receive UE capability information related to support for a full rated PA and the like from the user terminal 20. The control section 110 may control the UE that has reported these pieces of capability information so as to generate DCI to perform full power transmission. The transmitting/receiving section 120 may transmit control information for uplink signal transmission in a certain band to the user terminal 20.

### (User Terminal)

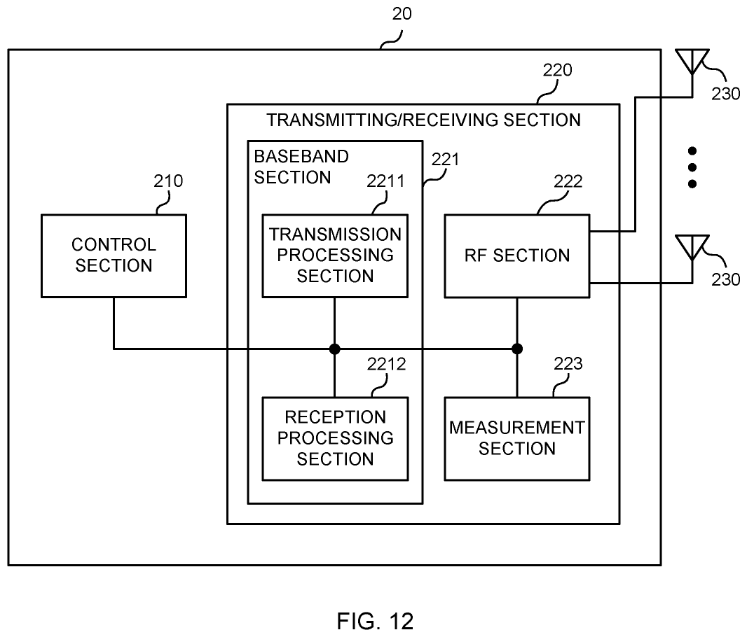

FIG. 12 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a certain channel (for example, PUSCH), the DFT processing as the above-described transmission processing to transmit the channel by using a DFT-s-OFDM waveform if transform precoding is enabled, and otherwise, does not need to perform the DFT processing as the above-described transmission process.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply a receiving process such as analog-digital conversion, FFT processing, IDFT processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 220 (measurement section 223) may perform the measurement related to the received signal. For example, the measurement section 223 may perform RRM measurement, CSI measurement, and so on, based on the received signal. The measurement section 223 may measure a received power (for example, RSRP), a received quality (for example, RSRQ, SINR, SNR), a signal strength (for example, RSSI), channel information (for example, CSI), and so on. The measurement results may be output to the control section 210.

Note that the transmitting section and the receiving section of the user terminal 20 in the present disclosure may be constituted with at least one of the transmitting/receiving section 220 and the transmitting/receiving antennas 230.

Note that the transmitting/receiving section 220 may receive control information for transmission of an uplink signal in a certain band. For example, when the uplink signal is a PUSCH or a DMRS, the certain band may correspond to a frequency domain resource (PRB) to be scheduled, and the control information may correspond to at least one of DCI and RRC signaling. When the uplink signal is an SRS, the certain band may correspond to a band for an SRS resource, and the control information may correspond to at least one of DCI and RRC signaling.

The control section 210 may perform control to allocate, to a plurality of sets of frequency resources less than 1 resource block included in the certain band, corresponding parts of the uplink signal that correspond to the plurality of sets, and simultaneously transmit the corresponding parts of the uplink signal (full power transmission). Note that the sets of frequency resource less than 1 resource block may be referred to as RE sets.

The control section 210 may simultaneously transmit the corresponding parts of the uplink signal by using a different antenna port for each of the plurality of sets.

The control section 210 may assume that structures of the plurality of sets are different from each other on the basis of which of a data signal (e.g., a PUSCH) or a reference signal (e.g., a DMRS, an SRS, or the like) the uplink signal is.

The control section 210 may generate the uplink signal on the basis of a sequence length (or modulation signal) determined with use of a bandwidth of the certain band, or may generate the uplink signal on the basis of at least one of a bandwidth for each RE set, a location or the number of REs included in each set, and the like. For example, the corresponding part of the uplink signal allocated to a certain RE set may correspond to part of a sequence with the sequence length determined with use of the bandwidth of the certain band, or may correspond to all of a sequence with a sequence length determined for each RE set.

The control section 210 may control, on the basis of a bandwidth of the certain band, whether to allocate the corresponding parts of the uplink signal to the plurality of sets included in the certain band and simultaneously transmit the corresponding parts of the uplink signal, or to allocate the corresponding parts of the uplink signal to a plurality of other sets of frequency resources equal to or greater than 1 resource block included in the certain band and simultaneously transmit the corresponding parts of the uplink signal. Note that the sets of frequency resource equal to or greater than 1 resource block (or with a unit of 1 resource block or more) may be referred to as RB sets.

### (Hardware Structure)

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining softwares into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit),” a “transmitter,” and the like. The method for implementing each component is not particularly limited as described above.

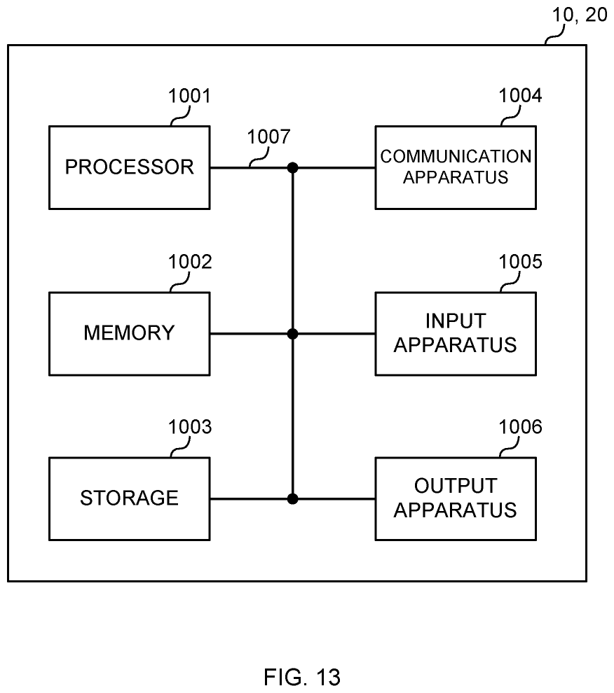

For example, a base station, a user terminal, and so on according to one embodiment of the present disclosure may function as a computer that executes the processes of the radio communication method of the present disclosure. FIG. 13 is a diagram to show an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably interpreted. The hardware structure of the base station 10 and the user terminal 20 may be configured to include one or more of apparatuses shown in the drawings, or may be configured not to include part of apparatuses.

For example, although only one processor 1001 is shown, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminals 20 is implemented, for example, by allowing certain software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least part of the above-described control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register,” a “cache,” a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “secondary storage apparatus.”

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the above-described transmitting/receiving section 120 (220), the transmitting/receiving antennas 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the base station 10 and the user terminals 20 may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

### (Variations)

Note that the terminology described in the present disclosure and the terminology that is needed to understand the present disclosure may be replaced by other terms that convey the same or similar meanings. For example, a “channel,” a “symbol,” and a “signal” (or signaling) may be interchangeably interpreted. Also, “signals” may be “messages.” A reference signal may be abbreviated as an “RS,” and may be referred to as a “pilot,” a “pilot signal,” and so on, depending on which standard applies. Furthermore, a “component carrier (CC)” may be referred to as a “cell,” a “frequency carrier,” a “carrier frequency” and so on.

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a particular filter processing performed by a transceiver in the frequency domain, a particular windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably interpreted.

For example, one subframe may be referred to as a “TTI,” a plurality of consecutive subframes may be referred to as a “TTI,” or one slot or one mini-slot may be referred to as a “TTI.” That is, at least one of a subframe and a TTI may be a subframe (1 ms) in existing LTE, may be a shorter period than 1 ms (for example, 1 to 13 symbols), or may be a longer period than 1 ms. Note that a unit expressing TTI may be referred to as a “slot,” a “mini-slot,” and so on instead of a “subframe.”

Here, a TTI refers to the minimum time unit of scheduling in radio communication, for example. For example, in LTE systems, a base station schedules the allocation of radio resources (such as a frequency bandwidth and transmit power that are available for each user terminal) for the user terminal in TTI units. Note that the definition of TTIs is not limited to this.

TTIs may be transmission time units for channel-encoded data packets (transport blocks), code blocks, or codewords, or may be the unit of processing in scheduling, link adaptation, and so on. Note that, when TTIs are given, the time interval (for example, the number of symbols) to which transport blocks, code blocks, codewords, or the like are actually mapped may be shorter than the TTIs.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot” and so on. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),” a “PRB pair,” an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for the UL) and a DL BWP (BWP for the DL). One or a plurality of BWPs may be configured in one carrier for a UE.

At least one of configured BWPs may be active, and a UE does not need to assume to transmit/receive a certain signal/channel outside active BWPs. Note that a “cell,” a “carrier,” and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Also, the information, parameters, and so on described in the present disclosure may be represented in absolute values or in relative values with respect to certain values, or may be represented in another corresponding information. For example, radio resources may be specified by certain indices.

The names used for parameters and so on in the present disclosure are in no respect limiting. Furthermore, mathematical expressions that use these parameters, and so on may be different from those expressly disclosed in the present disclosure. For example, since various channels (PUCCH, PDCCH, and so on) and information elements can be identified by any suitable names, the various names allocated to these various channels and information elements are in no respect limiting.

The information, signals, and so on described in the present disclosure may be represented by using any of a variety of different technologies. For example, data, instructions, commands, information, signals, bits, symbols, chips, and so on, all of which may be referenced throughout the herein-contained description, may be represented by voltages, currents, electromagnetic waves, magnetic fields or particles, optical fields or photons, or any combination of these.

Also, information, signals, and so on can be output in at least one of from higher layers to lower layers and from lower layers to higher layers. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or appended. The information, signals, and so on that are output may be deleted. The information, signals, and so on that are input may be transmitted to another apparatus.

Reporting of information is by no means limited to the aspects/embodiments described in the present disclosure, and other methods may be used as well. For example, reporting of information in the present disclosure may be implemented by using physical layer signaling (for example, downlink control information (DCI), uplink control information (UCI), higher layer signaling (for example, Radio Resource Control (RRC) signaling, broadcast information (master information block (MIB), system information blocks (SIBs), and so on), Medium Access Control (MAC) signaling and so on), and other signals or combinations of these.

Note that physical layer signaling may be referred to as “Layer 1/Layer 2 (L1/L2) control information (L1/L2 control signals),” “L1 control information (L1 control signal),” and so on. Also, RRC signaling may be referred to as an “RRC message,” and can be, for example, an RRC connection setup message, an RRC connection reconfiguration message, and so on. Also, MAC signaling may be reported using, for example, MAC control elements (MAC CEs).

Also, reporting of certain information (for example, reporting of “X holds”) does not necessarily have to be reported explicitly, and can be reported implicitly (by, for example, not reporting this certain information or reporting another piece of information).

Determinations may be made in values represented by one bit (0 or 1), may be made in Boolean values that represent true or false, or may be made by comparing numerical values (for example, comparison against a certain value).

Software, whether referred to as “software,” “firmware,” “middleware,” “microcode,” or “hardware description language,” or called by other terms, should be interpreted broadly to mean instructions, instruction sets, code, code segments, program codes, programs, subprograms, software modules, applications, software applications, software packages, routines, subroutines, objects, executable files, execution threads, procedures, functions, and so on.

Also, software, commands, information, and so on may be transmitted and received via communication media. For example, when software is transmitted from a website, a server, or other remote sources by using at least one of wired technologies (coaxial cables, optical fiber cables, twisted-pair cables, digital subscriber lines (DSL), and so on) and wireless technologies (infrared radiation, microwaves, and so on), at least one of these wired technologies and wireless technologies are also included in the definition of communication media.

The terms “system” and “network” used in the present disclosure can be used interchangeably. The “network” may mean an apparatus (for example, a base station) included in the network.

In the present disclosure, the terms such as “precoding,” a “precoder,” a “weight (precoding weight),” “quasi-co-location (QCL),” a “Transmission Configuration Indication state (TCI state),” a “spatial relation,” a “spatial domain filter,” a “transmit power,” “phase rotation,” an “antenna port,” an “antenna port group,” a “layer,” “the number of layers,” a “rank,” a “resource,” a “resource set,” a “resource group,” a “beam,” a “beam width,” a “beam angular degree,” an “antenna,” an “antenna element,” a “panel,” and so on can be used interchangeably.

In the present disclosure, the terms such as a “base station (BS),” a “radio base station,” a “fixed station,” a “NodeB,” an “eNB (eNodeB),” a “gNB (gNodeB),” an “access point,” a “transmission point (TP),” a “reception point (RP),” a “transmission/reception point (TRP),” a “panel,” a “cell,” a “sector,” a “cell group,” a “carrier,” a “component carrier,” and so on can be used interchangeably. The base station may be referred to as the terms such as a “macro cell,” a small cell,” a “femto cell,” a “pico cell,” and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

At least one of a base station and a mobile station may be referred to as a “transmitting apparatus,” a “receiving apparatus,” a “radio communication apparatus,” and so on. Note that at least one of a base station and a mobile station may be device mounted on a moving object or a moving object itself, and so on. The moving object may be a vehicle (for example, a car, an airplane, and the like), may be a moving object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor, and the like.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D),” “Vehicle-to-Everything (V2X),” and the like). In this case, user terminals 20 may have the functions of the base stations 10 described above. The words “uplink” and “downlink” may be interpreted as the words corresponding to the terminal-to-terminal communication (for example, “side”). For example, an uplink channel, a downlink channel and so on may be interpreted as a side channel.

Likewise, the user terminal in the present disclosure may be interpreted as base station. In this case, the base station 10 may have the functions of the user terminal 20 described above.

Actions which have been described in the present disclosure to be performed by a base station may, in some cases, be performed by upper nodes. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

The aspects/embodiments illustrated in the present disclosure may be used individually or in combinations, which may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods and next-generation systems that are enhanced based on these. A plurality of systems may be combined (for example, a combination of LTE or LTE-A and 5G, and the like) and applied.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “judging (determining)” as in the present disclosure herein may encompass a wide variety of actions. For example, “judging (determining)” may be interpreted to mean making “judgments (determinations)” about judging, calculating, computing, processing, deriving, investigating, looking up, search and inquiry (for example, searching a table, a database, or some other data structures), ascertaining, and so on.

Furthermore, “judging (determining)” may be interpreted to mean making “judgments (determinations)” about receiving (for example, receiving information), transmitting (for example, transmitting information), input, output, accessing (for example, accessing data in a memory), and so on.

In addition, “judging (determining)” as used herein may be interpreted to mean making “judgments (determinations)” about resolving, selecting, choosing, establishing, comparing, and so on. In other words, “judging (determining)” may be interpreted to mean making “judgments (determinations)” about some action.

In addition, “judging (determining)” may be interpreted as “assuming,” “expecting,” “considering,” and the like.

“The maximum transmit power” according to the present disclosure may mean a maximum value of the transmit power, may mean the nominal maximum transmit power (the nominal UE maximum transmit power), or may mean the rated maximum transmit power (the rated UE maximum transmit power).

The terms “connected” and “coupled,” or any variation of these terms as used in the present disclosure mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access.”

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other.” Note that the phrase may mean that “A and B is each different from C.” The terms “separate,” “be coupled,” and so on may be interpreted similarly to “different.”

When terms such as “include,” “including,” and variations of these are used in the present disclosure, these terms are intended to be inclusive, in a manner similar to the way the term “comprising” is used. Furthermore, the term “or” as used in the present disclosure is intended to be not an exclusive disjunction.

For example, in the present disclosure, when an article such as “a,” “an,” and “the” in the English language is added by translation, the present disclosure may include that a noun after these articles is in a plural form.

Now, although the invention according to the present disclosure has been described in detail above, it should be obvious to a person skilled in the art that the invention according to the present disclosure is by no means limited to the embodiments described in the present disclosure. The invention according to the present disclosure can be implemented with various corrections and in various modifications, without departing from the spirit and scope of the invention defined by the recitations of claims. Consequently, the description of the present disclosure is provided only for the purpose of explaining examples, and should by no means be construed to limit the invention according to the present disclosure in any way.

1. A user terminal comprising:
a receiving section that receives control information for transmission of an uplink signal in a certain band; and
a control section that performs control to allocate, to a plurality of sets of frequency resources less than 1 resource block included in the certain band, corresponding parts of the uplink signal that correspond to the plurality of sets, and simultaneously transmit the corresponding parts of the uplink signal.

2. The user terminal according to claim 1, wherein the control section simultaneously transmits the corresponding parts of the uplink signal by using a different antenna port for each of the plurality of sets.

3. The user terminal according to claim 1, wherein the control section assumes that structures of the plurality of sets are different from each other on the basis of which of a data signal or a reference signal the uplink signal is.

4. The user terminal according to claim 1, wherein the control section generates the uplink signal on the basis of a sequence length determined with use of a bandwidth of the certain band.

5. The user terminal according to claim 1, wherein the control section controls, on the basis of a bandwidth of the certain band, whether to allocate the corresponding parts of the uplink signal to the plurality of sets included in the certain band and simultaneously transmit the corresponding parts of the uplink signal, or to allocate the corresponding parts of the uplink signal to a plurality of other sets of frequency resources equal to or greater than 1 resource block included in the certain band and simultaneously transmit the corresponding parts of the uplink signal.

6. A radio communication method for a user terminal, the radio communication method comprising:
receiving control information for transmission of an uplink signal in a certain band; and
performing control to allocate, to a plurality of sets of frequency resources less than 1 resource block included in the certain band, corresponding parts of the uplink signal that correspond to the plurality of sets, and simultaneously transmitting the corresponding parts of the uplink signal.

7. The user terminal according to claim 2, wherein the control section assumes that structures of the plurality of sets are different from each other on the basis of which of a data signal or a reference signal the uplink signal is.

8. The user terminal according to claim 2, wherein the control section generates the uplink signal on the basis of a sequence length determined with use of a bandwidth of the certain band.

9. The user terminal according to claim 3, wherein the control section generates the uplink signal on the basis of a sequence length determined with use of a bandwidth of the certain band.

10. The user terminal according to claim 2, wherein the control section controls, on the basis of a bandwidth of the certain band, whether to allocate the corresponding parts of the uplink signal to the plurality of sets included in the certain band and simultaneously transmit the corresponding parts of the uplink signal, or to allocate the corresponding parts of the uplink signal to a plurality of other sets of frequency resources equal to or greater than 1 resource block included in the certain band and simultaneously transmit the corresponding parts of the uplink signal.

11. The user terminal according to claim 3, wherein the control section controls, on the basis of a bandwidth of the certain band, whether to allocate the corresponding parts of the uplink signal to the plurality of sets included in the certain band and simultaneously transmit the corresponding parts of the uplink signal, or to allocate the corresponding parts of the uplink signal to a plurality of other sets of frequency resources equal to or greater than 1 resource block included in the certain band and simultaneously transmit the corresponding parts of the uplink signal.

12. The user terminal according to claim 4, wherein the control section controls, on the basis of a bandwidth of the certain band, whether to allocate the corresponding parts of the uplink signal to the plurality of sets included in the certain band and simultaneously transmit the corresponding parts of the uplink signal, or to allocate the corresponding parts of the uplink signal to a plurality of other sets of frequency resources equal to or greater than 1 resource block included in the certain band and simultaneously transmit the corresponding parts of the uplink signal.
